(19) United States
(12) Patent Application Publication
(10) Pub. No.: US 2013/0056937 A1
(43) Pub. Date: Mar. 7, 2013

(54) Sealing Collar

(71) Applicant: Markus Watermann, Horn-Bad- Meinberg (DE)

(72) Inventor: Markus Watermann, Horn-Bad- Meinberg (DE)

(21) Appl. No.: 13/695,468

(22) PCT Filed: Sep. 9, 2010
(86) PCT No.: PCT/DE10/01063

§ 371 Date: Oct. 31, 2012

(30) Foreign Application Priority Data
Apr. 28, 2010 (DE) 10 2010 018 677.5

(51) Int. Cl. F16L 5/10; B23P 17/00

(52) U.S. Cl. 277/606; 29/890.14

(57) ABSTRACT

A sealing collar for sealing the transition between a wall and a pipe or the like protruding from the wall, having a central opening dimensioned so as to be smaller than the cross section of the pipe, a separately formed, flexible center portion is provided and a wall contact element is joined to the center portion at the edge thereof.

### CROSS REFERENCE TO RELATED APPLICATIONS

This is a U.S. national stage of application No. PCT/DE2010/001063, filed on 9 Sep. 2010. Priority is claimed on German, Application No. 10 2010 018 677.5, filed 28 Apr. 2010, the content of which is incorporated here by reference.

### BACKGROUND OF THE INVENTION

1. Field of the Invention

The invention is directed to a flexible sealing collar for sealing a transition between a wall and a pipe or the like protruding from the wall, having a central opening, which is dimensioned so as to be smaller than the cross section of the pipe.

2. Description of the Prior Art

Sealing collars of the type mentioned above are known and established in a wide variety of embodiment forms. They are usually used in a wet area of a residence such as in a bath, shower, etc. and usually seal a water pipe relative to a wall, which is covered, e.g., with tiles beyond the sealing collar.

DE 41 31 637 A1 discloses a flexible sealing collar of this kind that adheres well to a vertical wall and also to a covering such as tiles. A secure sealing between pipe and masonry is to be provided in this way.

For this purpose, the sealing collar, which is made of a flexible material is provided on at least one side with an open-pore or fibrous cover layer that leaves an annular area open around the opening so as not to impair the flexibility of the area and to ensure that this flexible center portion contacts the pipe securely. This requires a substantial expenditure for production.

In addition, as a result of the composite, these known sealing collars have comparatively cumbersome dimensions to ensure a durable sealing of the transition between the wall and a pipe protruding from the wall. To counter this problem, it is known to use a relatively thin PVC film as substrate material, although this has proven unsuitable in more recent testing procedures because PVC is not resistant to alkali and becomes brittle very quickly under the influence of alkali so that a sealing function is no longer ensured.

Further, it has turned out to be problematic in the production of known sealing collars to provide them with a self-adhering coating on the side facing the wall. An adhesive coating of this kind also often covers the flexible center part and a sealing collar of this kind can hardly be used anymore because when the collars are applied they stick to the pipe, a plug, or the like, and not to the wall.

Moreover, the known sealing collar has the basic problem that the entire sealing collar is deformed when it is placed over a pipe and contacts the wall so that it often can no longer contact the wall in a planar, flat manner.

### SUMMARY OF THE INVENTION

This set of problems is overcome according to one embodiment of the invention as a sealing collar for sealing the transition between a wall and a pipe or the like protruding from the wall, having a central opening dimensioned so as to be smaller than the cross section of the pipe, a separately formed, flexible center portion is provided, and a wall contact element is affixed to the center portion at the edge of the sealing collar. A sealing collar of this kind affords a variety of advantages over conventional sealing collars.

First, by a special choice of material for the center portion and wall contact element the sealing collar according to one embodiment of the invention offers the possibility of optimizing its function. For this purpose, the center portion comprises a particularly flexible plastic, while the wall contact element is formed by a comparatively stiff material, which can nevertheless bond easily with glue, mortar, or the like.

In particular, the wall contact element can be a nonwoven fabric, for example, a PP spunbond such as is routinely used for sealing walls. In so doing, no problem is presented by forming this nonwoven fabric such that a film is laminated thereto, for example, so as also to be self-adhering, without the flexible center portion being damaged.

The center portion formed of a very flexible material, for example, a TPE, can be inserted into an aperture of the wall contact element so as to fit exactly or, alternatively, the center portion and the wall contact element can overlap.

Depending on the construction and the materials used, the center portion and the wall contact element can be connected by virtually any conventional joining method such as ultrasonic welding, microwave welding, or other thermal processes, possibly also by suitable glues.

Regardless of whether the wall contact element is a composite material, a composite of nonwovens or films, it has proven expedient when a nonwoven fabric is laminated to the overlapped flat side of the wall contact element. In the absence of the overlapped area, this nonwoven fabric can provide height compensation or, if the overlapped area or possibly the entire center portion with the exception of the central opening is covered by a nonwoven fabric of this kind, can provide a very good bond to a glue, a mortar, or the like.

Notwithstanding the above, it is further provided that the elasticity modulus of the wall contact element is greater than that of the center portion. Given a suitable choice of material, this allows an optimal contact of the flexible center portion to the pipe on the one hand and an optimal contact of the wall contact element to a wall on the other hand.

For further optimization of contact at the wall, possibly also accompanied by a certain tensioning of the wall contact element, it can further be provided that the wall contact element is provided with holes extending along the aperture circumferentially around the edge at the outer edge and inner edge, wherein two parallel rows of holes are preferably provided in a staggered manner. If required, the holes can be further reinforced against tearing by an edge reinforcement or by applying a strip. Alternatively, perforations are possible, also over the entire surface of the wall contact element if required, to allow a certain permeability to steam which, moreover, is adjustable through the degree of perforation. Other alternatives include notches or cutouts at the edge through which projecting tabs in a wide variety of shapes can be formed.

Comparable to the above, it can be provided for purposes of improving the adherence of the wall contact element to the center portion that the aperture in the wall contact element is oval, round or is a polygonal line which, if required, can be additionally provided with notches.

Further, the sealing collar according to one embodiment of the invention is also characterized by very simple production methods for which application is made for separate protection.

In a first method for producing a sealing collar for sealing the transition between a wall and a pipe or the like protruding from the wall, particularly as described above, a cutting of a wall contact element is carried out, wherein a central aperture whose dimensions are greater than the dimensions of the pipe is introduced into the wall contact element, in that a cutting of a flexible center portion is carried out, the dimensions thereof being equal to or greater than those of the central aperture and which is provided with a central opening whose dimensions are smaller than those of the pipe, and in that the center portion and the wall contact element are joined together in an exactly fitting manner or with overlapping.

This method has the advantage that it allows the cutting of the wall contact element and the cutting of the flexible center portion to be separate. For example, this allows remainders from other production processes for producing seals or the like to be used for producing the sealing collar. An optional choice of color is also possible without any problems so that a customer may be supplied with sealing collars in special recurring color combinations.

In an alternative production method for a sealing collar, particularly according to one embodiment of the invention, after the cutting of a wall contact element corresponding to the method described above, a flexible center portion is inserted into and joined to the central aperture in an injection molding machine, wherein a fusing of the flexible center portion and wall contact element is brought about in an overlapping area, but apart from this, as a result of cooling, the mold leaves the rest of the material of the wall contact element undamaged.

Further, through corresponding fashioning of the mold, this method affords the possibility of designing different surfaces of the center portion, e.g., with markings, order numbers, or the like. It is also possible to adjust the material thickness of the flexible center portion. Further, center portions of this kind can be provided which overlap the flat sides of the wall contact element on one side or, if required, on both sides.

### BRIEF DESCRIPTION OF THE DRAWINGS

The sealing collar and the production thereof will be described in more detail with reference to the drawings in which embodiment examples are only shown schematically. The drawings show:

FIG. 1 is a top view of a sealing collar with a center portion which is arranged in an exactly fitting manner;

FIG. 2 is a section according to line II, II in FIG. 1;

FIG. 3 is a top view of a sealing collar with a center portion overlapping the wall contact element;

FIG. 4 is a section according to line IV, IV in FIG. 3;

FIG. 5 is a section through another embodiment example; and

FIG. 6 is a top view of a sealing collar taken as basis for the description of further variants.

### DETAILED DESCRIPTION OF THE PREFERRED EMBODIMENTS

FIG. 1 is a top view of a sealing collar 1 according to one embodiment of the invention approximately in scale. A central, separately formed center portion 2 has an opening 3 having, in this case, a circular cross section and whose diameter is less than that of a pipe protruding from a wall, so that the center portion 2 is arranged on such a pipe under tension.

Corresponding to the opening 3, the center portion 2 also has a circular shape. Other geometric shapes are also possible without any problem, for example, for a pipe having a square cross section or rectangular cross section like that of a cable conduit.

The flexible center portion 2 is to be inserted in an exactly fitting manner into a central aperture 4 of a comparatively rigid wall contact element 5 as is shown in the left-hand half of FIG. 1, wherein the diameter of the aperture 4 is greater than that of the pipe protruding from a wall.

The flexible center portion 2 which has a lower elasticity modulus than the wall contact element 5 and is connected to the contact element 5 by ultrasonic welding, microwave welding, by a heated annular die, possibly by suitable glues, or another joining method.

Alternatively, it is possible to insert a blank of the wall contact element 5 in an injection molding machine and to form the center portion 2 separately therein. If, in so doing, a region of the wall contact element 5 which is offset slightly from the aperture 4 is cooled, a seam zone 6 results as in other joining processes or gluing process—right-hand half of FIG. 1.

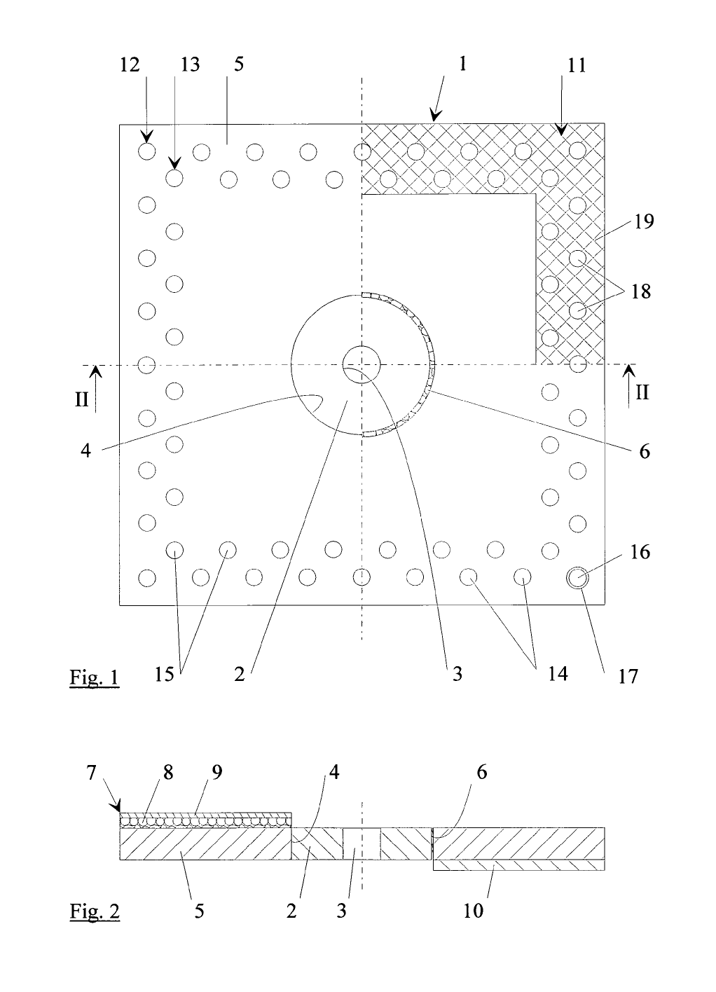

The wall contact element 5 is constructed as a separate blank entirely independent of the flexible center portion 2 and therefore, when formed as a nonwoven fabric, for instance, can have a lamination 7 a glue layer 8, which is itself covered by a cover film 9 shown on the left-hand half of FIG. 2.

If the wall contact element 5 is formed, for example, by a comparatively smooth sheet, a nonwoven fabric 10 can be laminated to it particularly on the wall side as shown in FIG. 3, on the right-hand half, so that a composite of this kind can also adhere well to a wall.

Alternatively, possibly in addition to a self-adhering coating like the lamination 7 comprising glue layer 8 and cover film 9, for a planar contact of the wall contact element 5 at a wall or the like, the sealing collar 1 can be provided with holes 11 extending around the edge and comprising in this instance two rows 12, 13 of holes 14, 15. These holes 14, 15 are staggered so that there is no danger of tearing out of the holes 14, 15 when the sealing collar 1 is tensioned and fastened to an expanded mesh or the like by tacks or nails.

If required, a hole 16, only indicated in FIG. 1, can be provided additionally with an edge reinforcement 17 by fusing or the like of the material of the wall contact element 5 when introducing the hole 16.

An alternative to this type of edge reinforcement of an individual hole 16 is shown in the first quadrant of FIG. 1, where holes 18 are reinforced by a strip 19 arranged on the wall contact element 5.

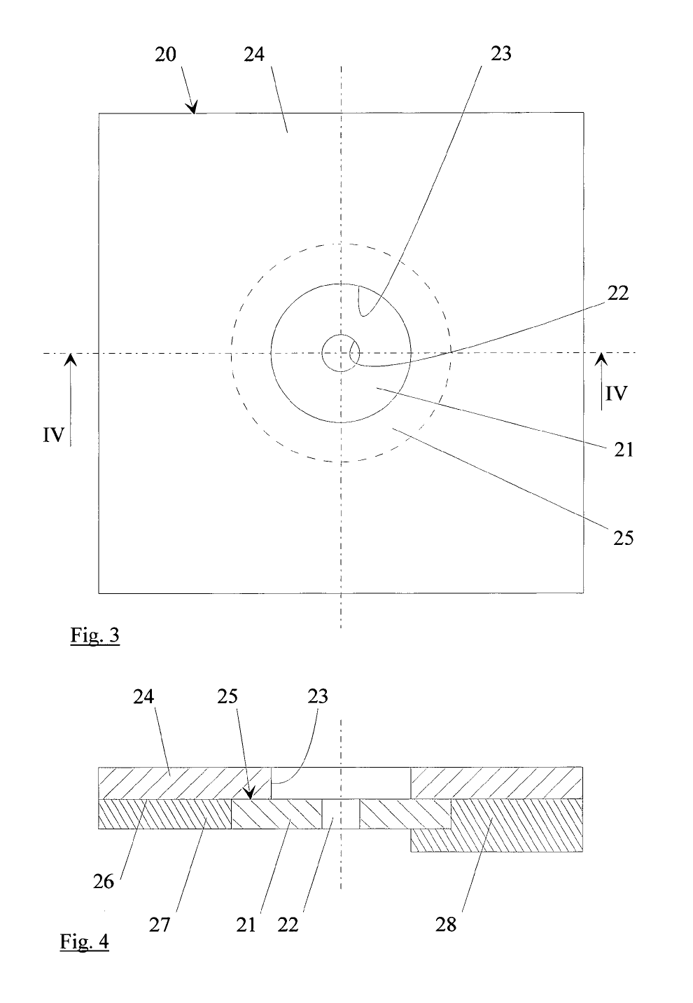

In the embodiment example of a sealing collar 20 according to FIGS. 3 and 4, the flexible center portion 21 overlaps with central opening 22 and the wall contact element 24. Correspondingly, the dimensions of the center portion 21 are greater than those of an aperture 23 in the wall contact element 24. In this case also, suitable joining methods or gluing methods produce a particularly tension-resistant connection between the center portion 21 and the wall contact element 24, a comparatively large overlapping area 25 being available for this purpose. In order to compensate for the height difference between the overlapped flat side 26 of the wall contact element 24 and the overlapping region 25, the overlapped flat side 26 can be covered additionally by a nonwoven fabric 27—compare left-hand half of FIG. 4.

If the overlapping region 25 is very large, it is also conceivable to improved bonding with a glue, mortar, or the like to laminate a nonwoven fabric 28 beyond the center portion 21, preferably up to the contour of the aperture 23—compare right-hand half of FIG. 4—but possibly also up to the opening 22.

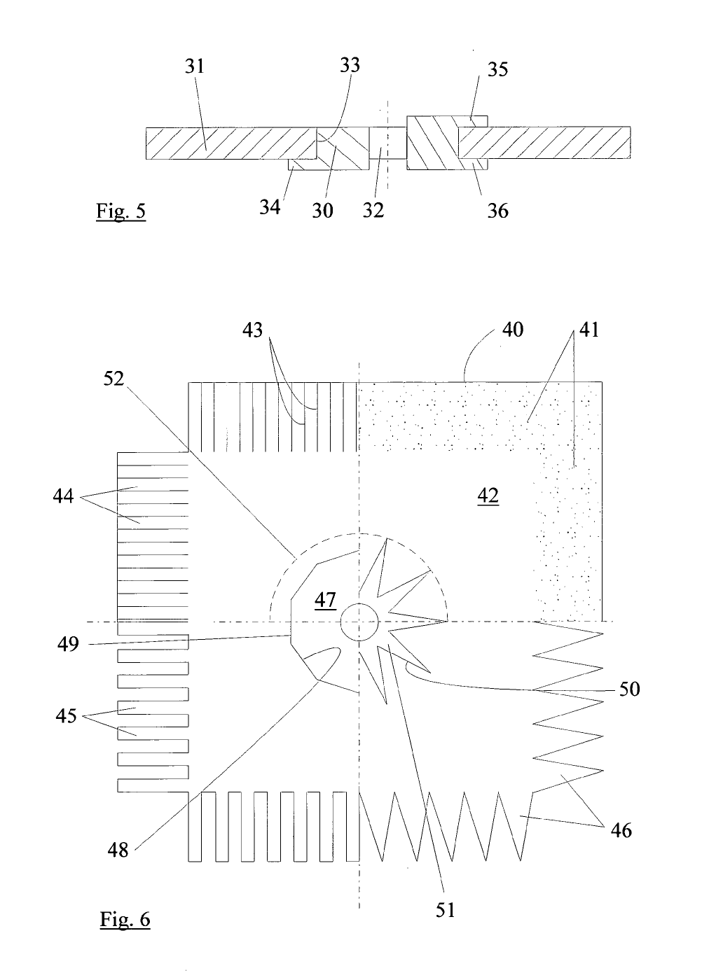

Producing a flexible center portion 30 according to FIG. 5 in an injection molding machine with inserted wall contact element 31 advantageously affords a combination of an exactly fitting insertion of the center portion 30 provided with a central opening 32 into an aperture 33 with an overlap 34 on one side—compare left-hand half of FIG. 5—or also with overlapping 35, 36 on both sides—right-hand half of FIG. 5—so that the wall contact element 31 is bookended by the center portion 30 in a manner of speaking.

Further, introducing the center portion in an injection molding machine affords the possibility of providing the center portion with logos, numbers or the like by configuring the mold in a corresponding manner.

A number of other variants of the sealing collar according to embodiments of the invention are described with reference to FIG. 6; the edge contour 40 is not limited to the square or rectangular shapes illustrated therein. Round-oval or polygonal lines are also possible with no problems. However, in order to improve adhesion of the sealing collar particularly at the edge side, a perforation 41 in the form of an edge strip can be provided instead of, or in addition to, holes as is indicated in the upper right-hand part of FIG. 6.

A perforation 41 of this kind can also extend over the entire wall contact element 42 if necessary, so that a sealing collar which is perforated in this manner is permeable to steam to a certain extent.

Another alternative for improved adhesion at the edges can be simple notches 43 through which a plurality of tabs 44 are formed directly adjoining one another as is shown in the upper left-hand part of FIG. 6.

Isolated tabs 45 which are spaced apart for improved edge adhesion are shown in the lower left-hand part of FIG. 6; tabs in the form of teeth 46 are shown in the lower right-hand part.

Bonding between a center portion 47 and the wall contact element 42 can also be improved in a comparable manner in that an aperture 48 is formed by a polygonal line 49 in the form of a polygon—lower left-hand part of FIG. 6—or a star-shaped polygonal line 50—lower right-hand part of FIG. 6—in which the center portions 47, 51 can be inserted in an exactly fitting manner as shown in the bottom half of the drawing.

Alternatively, an overlapping of a center portion 52 is also possible without problems when apertures 48 are shaped in this way as is indicated in the top half of FIG. 6.

Further, a wide variety of possible combinations are also given, particularly combined with tabs, perforations and holes.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A sealing collar configured to seal a transition between a wall and an element protruding from the wall, comprising:
a wall contact element defining a central opening dimensioned to be smaller than a cross section of the element protruding from the wall; and
a flexible center portion that is formed separately from the wall contact element,
wherein the wall contact element is joined to the flexible center portion at a radial outer edge of the flexible center portion.

13. The sealing collar according to claim 12, wherein the flexible center portion is inserted into the central opening defined by the wall contact element to fit substantially exactly.

14. The sealing collar according to claim 12, wherein the flexible center portion and the wall contact element overlap on a first side of the wall contact element.

15. The sealing collar according to claim 14, wherein a nonwoven fabric is laminated to the first side of the wall contact element.

16. The sealing collar according to claim 12, wherein an elasticity modulus of the wall contact element is greater than an elasticity modulus of the flexible center portion.

17. The sealing collar according to claim 12, wherein the wall contact element is at least one of a nonwoven fabric, a composite of a nonwoven fabric, and a film.

18. The sealing collar according to claim 17, wherein the nonwoven fabric or the composite of a nonwoven fabric is provided with a lamination.

19. The sealing collar according to claim 12, wherein the wall contact element is provided with one or more of: holes, a perforation, tabs, and notches extending circumferentially around a radially outer edge of the wall contact element.

20. The sealing collar according to claim 12, wherein the central opening defined by the wall contact element is one of oval, round, and a polygonal line.

21. A method for producing a sealing collar for sealing a transition between a wall and a pipe protruding from the wall, comprising:
cutting a wall contact element to define a central aperture, wherein the central aperture whose dimensions are greater than the dimensions of the pipe is introduced into the wall contact element;
cutting a flexible center portion so that an outer dimension of the flexible center portion is one of equal to and greater than the central aperture and which defines a central opening whose dimensions are smaller than those of the pipe; and
joining the flexible center portion and the wall contact element in one of a substantially exactly fitting manner and an overlapping manner.

22. The method for producing a sealing collar according to claim 21, further comprising:
inserting and joining the flexible center portion to the central aperture in an injection molding machine.
